(19) United States
(12) Patent Application Publication
(10) Pub. No.: US 2025/0201444 A1
(43) Pub. Date: Jun. 19, 2025

(54) WIRE HARNESS WITH RFID TRACEABILITY

(71) Applicant: ELECTRICAL COMPONENTS INTERNATIONAL, INC., St. Louis, MO (US)

(72) Inventors: Mark Alan Sember, Milford, MI (US); Jarred Knecht, Westmont (CA)

(21) Appl. No.: 18/954,698

(22) Filed: Nov. 21, 2024

Related U.S. Application Data
(60) Provisional application No. 63/611,277, filed on Dec. 18, 2023.

(51) Int. Cl. H01B 7/36; B60R 16/02; H01B 7/00; H02G 1/06

(52) U.S. Cl. CPC H01B 7/368; B60R 16/0207; H01B 7/0045; H02G 1/06; H02G 2200/20

(57) ABSTRACT

A method of manufacturing a vehicle includes providing a part with a radio frequency identification (RFID) tag associated with part data, installing the part thereby obstructing the RFID tag, scanning the obstructed RFID tag to access the part data without disturbing the part, determining if the part data is correct for the installation, and certifying and releasing the installation when the part data is correct.

### CROSS-REFERENCE TO RELATED APPLICATION

This applications claims priority to U.S. Provisional Application No. 63/611,277 filed Dec. 18, 2023.

### TECHNICAL FIELD

This disclosure relates to using unique identifiers on parts, such as a wire harness, for traceability.

### BACKGROUND

Wire harnesses (also known as cable harnesses, cable assemblies, wiring assemblies, or wiring looms) are assemblies of electrical cables or wires that transmit signal and/or electrical power. Wire harnesses are commonly used in, for example, a vehicle, such as, an automobile, a heavy-duty transportation vehicle, such as a semi-truck, a train, a trolley or a cable car, a construction machine, a watercraft, such as a cargo vessel, an inter-island boat or a jet ski, and a spacecraft. Wire harnesses are primarily manufactured by hand, and are inspected during one or more stages of their manufacture to ensure quality and/or functionality.

### SUMMARY

In one exemplary embodiment, a method of manufacturing a vehicle includes providing a part with a radio frequency identification (RFID) tag associated with part data, installing the part thereby obstructing the RFID tag, scanning the obstructed RFID tag to access the part data without disturbing the part, determining if the part data is correct for the installation, and certifying and releasing the installation when the part data is correct.

In a further embodiment of any of the above, the part is a wire harness.

In a further embodiment of any of the above, the part data includes at least one of a product feature class including whether a component is acceptable or unacceptable, captured product image associated with the product feature class, a final verdict for the finished wire harness, and an inspection log.

In a further embodiment of any of the above, the product feature class relates to an inspection of at least one of a crimp connector, an endcap, a tie wrap, a sleeve, a crimp, a jacket, a lug, a heated heat shrink, welding, and a shield braid.

In a further embodiment of any of the above, the installing step includes installing the wire harness into an assembly including a battery pack and an electric motor.

In a further embodiment of any of the above, the installing step includes installing the wire harness into a vehicle.

In a further embodiment of any of the above, the scanning step is performed before the step of installing the wire harness into the vehicle.

In a further embodiment of any of the above, the scanning step is performed after the step of installing the wire harness into the vehicle.

In a further embodiment of any of the above, the determining step includes checking if the final verdict of the wire harness is a pass.

In a further embodiment of any of the above, the determining step includes checking a part revision in the inspection log.

In a further embodiment of any of the above, the determining step includes checking the part revision against part revision data of other components in the assembly.

In a further embodiment of any of the above, the scanning step includes simultaneously scanning other RFID tags of the other components.

In a further embodiment of any of the above, the determining step includes accessing the part data in cloud-based storage.

In a further embodiment of any of the above, the determining step includes determining the part data is incorrect, and comprising a step of removing and inspecting the wire harness.

### BRIEF DESCRIPTION OF THE DRAWINGS

The disclosure can be further understood by reference to the following detailed description when considered in connection with the accompanying drawings wherein:

FIG. 1 is a flow chart of a vehicle manufacturing process incorporating a part, such as a wire harness.

FIG. 2 is a schematic view of an example wire harness.

FIG. 3 is a schematic illustrate of one example vehicle incorporating the wire harness.

FIG. 4 is a method depicting a vehicle certification process.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

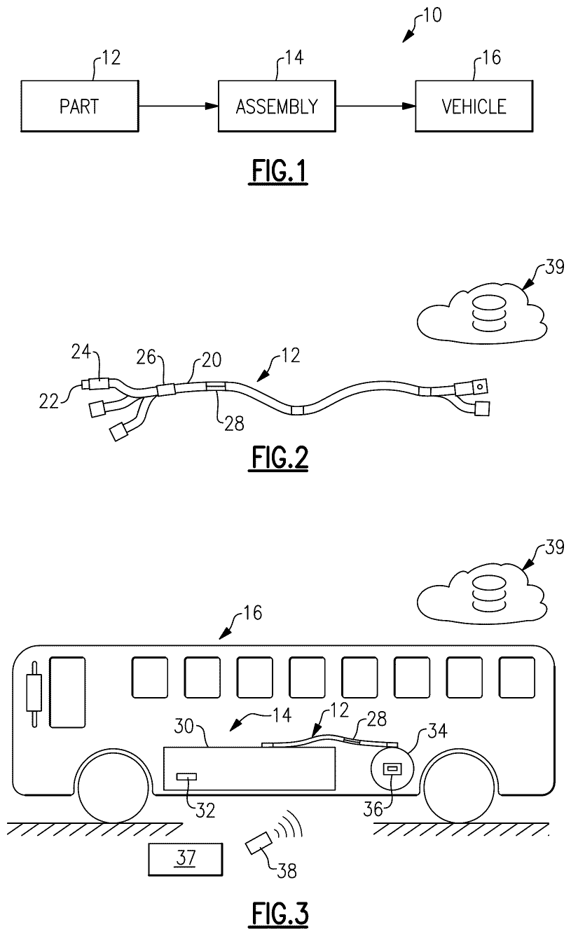

FIG. 1 illustrates a typical vehicle manufacturing process 10 at a high level. A part 12 is incorporated into an assembly 14 or sub-assembly that is installed into a vehicle 16. In one example, the part 12 is a wire harness, as shown in FIG. 2. For very demanding and complex applications, it may desirable to comprehensively inspect the part and provide traceability to the customer. One such example is high voltage wire harnesses used in electrified vehicles like commercial buses (FIG. 3).

The wire harness 12 may be constructed from a variety of components, such as cables 20, terminals 22, heat shrink 24, tape 26, and a unique identifier 28. The unique identifier 28 may be provided by an adhesive or printed label having a serialized bar code for the specific wire harness 12 to provide traceability back to its production. Alternatively or additionally, a radio frequency identification (RFID) tag may be attached as the unique identifier 28.

The unique identifier 28 is associated with part data gathered during manufacturing and inspection of the wire harness 12. Details of example wire harness inspections are described in U.S. patent application Ser. No. 17/853,188 entitled “NEXT GENERATION QUALITY INSPECTION”, filed on Jun. 29, 2022; and U.S. Patent Application No. 63/540,777 entitled “ENHANCED QUALITY CONTROL USING MACHINE LEARNING”, filed on Sep. 27, 2023, which are incorporated herein by reference in its entirety.

An example of the part data associated with the unique identifier 28 includes, for example, a product feature class (acceptable/unacceptable) and an associated captured product image for each component inspected (e.g., components 20-26), a final verdict (pass/fail) for the finished wire harness 12, and/or an inspection log (which may include part revision information). In the example of a wiring harness, the product features may include the quality and or placement of one or more of a crimp connector (e.g., Rosenberger (RSBRG) connector, lug connector, and/or Amphenol connector), an endcap, a tie wrap, a sleeve, a crimp, a jacket, a lug, a heated heat shrink, welding, and/or a shield braid. The unique identifier 28 and associated part data are stored for later access and use, for example, in a database on cloud-based storage 39 (FIG. 2).

In the example of a high voltage application, such as an electrified bus 16, the wire harness 12 is installed into a powertrain assembly 14 that includes a battery pack 30 and an electric motor 34. Typically, once installed at least portion of the wire harness 12 is obstructed and inaccessible (e.g., no line of sight to the unique identifier 28) by surrounding structure, which may be related to both safety and non-safety reasons. For example, it may be desirable to cover or enclose any components (e.g., lugs or terminals) that could inadvertently expose a person or metallic object to high voltage.

It may be desirable for manufacturers to scrutinize parts and/or assemblies for certain vehicles to a high degree, for example, commercial carrier vehicles and/or vehicles using electrification and/or autonomous driving features. These types of vehicles are more complex and demanding such that additional steps may be desired to further reduce a possible failure due to a defective or incorrect part. To this end, the disclosed method may be used by a manufacturer as an additional safeguard to ensure the assembly or vehicle has the correct part before leaving its possession and control.

An example manufacturing facility is illustrated in FIG. 3 and includes a computing device 37 in communicating with a scanner 38 and the cloud-based storage 39. In terms of hardware architecture, such a computing device 37 can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The computing device 37 may be a hardware device for executing software, particularly software stored in memory. The controller can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller is in operation, the processor can be configured to execute software stored within the memory, to communicate data to and from the memory, and to generally control operations of the computing device 37 pursuant to the software. Software in memory, in whole or in part, is read by the processor, perhaps buffered within the processor, and then executed.

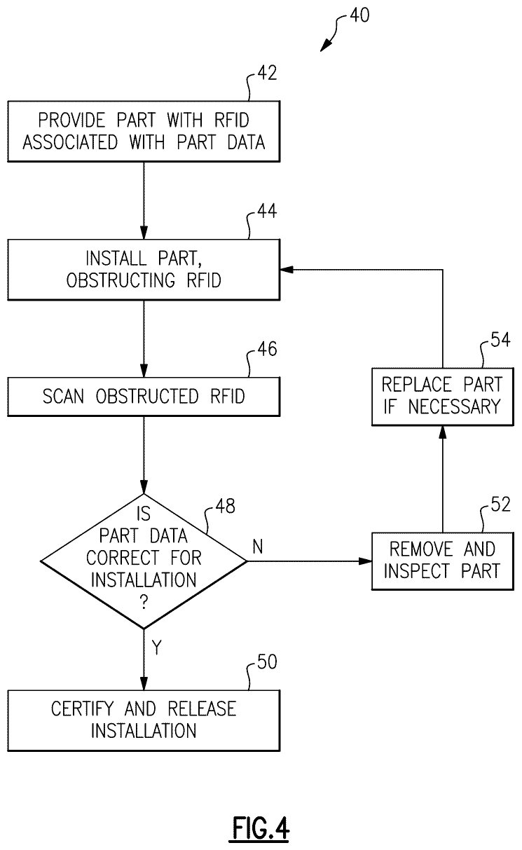

Referring to a method 40 shown in FIG. 4, at one or more times during manufacture of the assembly 14 and/or vehicle 16, the scanner 37 is used (e.g., by an operator) to read the unique identifier 28 (e.g., RFID tag), which is associated with the part data (block 42). The part is often installed with the unique identifier obstructed (block 44), which would prevent further checks of the part without disassembly (or exposure to high voltage in the case of wire harnesses used in electrified vehicles). The RFID tag is scanned while obstructed and without disturbing the part (block 46) to protect against any inadvertent exposure to high voltage in the case of an electrified powertrain. This scanning step can be performed upon installation of the wire harness 12 into the assembly (e.g., connecting the wire harness 12 to the battery pack 30 and electric motor 34) before installation of the assembly 14 into the vehicle 16, or after such installation.

In one example, the scanner 38 is in communication with the computing device 37 in the manufacturing facility, which is in turn in communication with the cloud-based storage 39 having the part data. The computing device 37 may also have access to component, assembly (e.g., specifications) and/or vehicle information (e.g., VIN, build sheet, etc.) This system is used to determine if the part data is correct for the installation (block 48), for example, checking if the final verdict of the wire harness is a pass (that is, if the scanned part a good part according to the part data) or if a part revision is correct for the assembly and/or vehicle being scanned. The part's revision may also be checked against part revision data of the other components (e.g., battery pack 30, electric motor 34), particularly if those components also have RFID tags (e.g., 32, 36) that can be scanned. Using the method, an operator can avoid exposure to high voltage components while providing improved quality control.

If the part data is correct for the installation, then the installation (assembly or vehicle) can be certified and released (block 50) by the manufacturer. If the part data is incorrect for the installation, the part is then removed and inspected (block 52) for further remedial action, such as part replacement (block 52). In this manner, an additional layer of quality control can be provided before the part leaves the manufacturer facility.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of manufacturing a vehicle, comprising:
providing a part with a radio frequency identification (RFID) tag associated with part data;
installing the part thereby obstructing the RFID tag;
scanning the obstructed RFID tag to access the part data without disturbing the part;
determining if the part data is correct for the installation; and
certifying and releasing the installation when the part data is correct.

2. The method of claim 1, wherein the part is a wire harness.

3. The method of claim 2, wherein the part data includes at least one of a product feature class including whether a component is acceptable or unacceptable, captured product image associated with the product feature class, a final verdict for the finished wire harness, and an inspection log.

4. The method of claim 3, wherein the product feature class relates to an inspection of at least one of a crimp connector, an endcap, a tie wrap, a sleeve, a crimp, a jacket, a lug, a heated heat shrink, welding, and a shield braid.

5. The method of claim 2, wherein the installing step includes installing the wire harness into an assembly including a battery pack and an electric motor.

6. The method of claim 5, wherein the installing step includes installing the wire harness into a vehicle.

7. The method of claim 5, wherein the scanning step is performed before the step of installing the wire harness into the vehicle.

8. The method of claim 5, wherein the scanning step is performed after the step of installing the wire harness into the vehicle.

9. The method of claim 5, wherein the determining step includes checking if the final verdict of the wire harness is a pass.

10. The method of claim 5, wherein the determining step includes checking a part revision in the inspection log.

11. The method of claim 10, wherein the determining step includes checking the part revision against part revision data of other components in the assembly.

12. The method of claim 11, wherein the scanning step includes simultaneously scanning other RFID tags of the other components.

13. The method of claim 2, wherein the determining step includes accessing the part data in cloud-based storage.

14. The method of claim 2, wherein the determining step includes determining the part data is incorrect, and comprising a step of removing and inspecting the wire harness.
